(19) United States
(12) Patent Application Publication
(10) Pub. No.: US 2008/0279742 A1
(43) Pub. Date: Nov. 13, 2008

(54) Method and Device For Desulfating a NOx Storage Catalyst

(75) Inventors: Tino Arlt, Regensburg (DE); Gerd Rosel, Regensburg (DE)

Correspondence Address: LERNER GREENBERG STEMER LLP, P O BOX 2480, HOLLYWOOD, FL, 33022-2480, US

(73) Assignee: VDO AUTOMOTIVE AG, Regensburg (DE)

(21) Appl. No.: 11/995,556

(22) PCT Filed: Jun. 29, 2006
(86) PCT No.: PCT/EP2006/063668

§ 371 Date: Jan. 14, 2008

(30) Foreign Application Priority Data
Jul. 14, 2005 (DE) 10 2005 032 941.1

(51) Int. Cl. B01D 53/50; B01D 53/96; F01N 3/20

(52) U.S. Cl. 423/242.2; 423/242.1; 423/244.01; 60/286; 60/295

(57) ABSTRACT

The desulfation of a NOx storage catalytic converter takes place in two phases. In a first phase, the NOx storage catalytic converter is alternately exposed to rich and lean exhaust gas. In a subsequent second phase, the NOx storage catalytic converter is operated using rich exhaust gas. This method permits the quantity of hydrogen sulfide that occurs during the desulfation process to be minimized and achieves at the same time an efficient removal of sulfate from the deep-seated layers of the NOx storage catalytic converter.

The present invention relates to a method and device for desulfating a NOx storage catalyst.

In order to be able to comply with statutory provisions, modern internal combustion engines have an exhaust gas purification system for purifying the exhaust gases produced during the combustion process. The exhaust gas purification system typically includes one or more catalytic converters and sensors for measuring air-fuel ratios and temperatures.

In the special case of internal combustion engines that operate in the superstoichiometric mode (lean operation), very many oxides of nitrogen (NOx) are produced. A particularly effective method of reducing the oxides of nitrogen is required as a result. In the passenger car sector of the automotive engineering field, NOx storage catalysts are the preferred method of solving this problem at the present time. With this type of catalytic converter, however, there arises the problem that sulfur contained in the fuel in the form of sulfates is also adsorbed in addition to the oxides of nitrogen contained in the exhaust gas. The sulfur compounds use the same chemical storage principle in the NOx storage catalyst and the same storage sites as the oxides of nitrogen. The oxides of nitrogen are bound to the storage components in the NOx storage catalyst as nitrates and the sulfur is bound in the form of sulfates.

During normal operation of a NOx storage catalyst, a NOx regeneration is performed at regular intervals. As is known, the regeneration of the NOx storage catalyst can be effected by a temporary enrichment of the mixture composition of the internal combustion engine, with the stored oxides of nitrogen being reduced in the process. However, the sulfates are not removed from the NOx storage catalyst during the NOx regeneration due to the fact that they are chemically more stable than the nitrates. This leads to an accumulation of sulfates in the NOx storage catalyst and consequently to a reduced capacity to store oxides of nitrogen.

For this reason it is necessary to perform a desulfation, i.e. a sulfur regeneration, of the NOx storage catalyst at certain intervals in order to remove the sulfates from the NOx storage catalyst and thereby increase the storage capacity for oxides of nitrogen. In order for the sulfates to be desorbed from the NOx storage catalyst, temperatures of approx. 650° C. to 800° C. are necessary in the NOx storage catalyst. At the same time rich exhaust gas, i.e. exhaust gas containing a high proportion of hydrocarbons and carbon monoxide, which is produced during substoichiometric operation (λ<1) of the internal combustion engine, is required in the NOx storage catalyst as a regeneration agent. Under these conditions the sulfates are released from the storage components in the NOx storage catalyst and hydrogen sulfide is produced. Following a desulfation of this kind, the storage components in the NOx storage catalyst are available once again for storing oxides of nitrogen as well as for trapping sulfur. A method of this kind for desulfating a NOx storage catalyst is described in DE 197 05 335 C1.

A disadvantage with said method is the fact that hydrogen sulfide is produced, which is perceived even in small concentrations as a very unpleasant odor. A further disadvantage is that the method results in high hydrocarbon and carbon monoxide emissions. For this reason a modified method is often resorted to during the desulfation, wherein the composition of the exhaust gas during the desulfation is periodically varied between rich (substoichiometric operation (λ<1) of the internal combustion engine) and lean (superstoichiometric operation (λ>1) of the internal combustion engine). In the lean phases, oxygen is introduced into the NOx storage catalyst and buffered there. In the rich phases, this oxygen serves to convert the resulting hydrogen sulfide into water and sulfur dioxide. Thus, this method has the advantage that only very small amounts of hydrogen sulfide are produced. Disadvantages with this method are the longer duration of the desulfation phase and higher fuel consumption. Furthermore, it also results in a reduced level of efficiency in respect of the removal of sulfates from deep NOx storage catalyst layers. A desulfation method of this kind is disclosed in DE 103 18 210 A1.

The object of the invention is to provide a method and device for desulfating a NOx storage catalyst which lessen the disadvantages of the two above-cited methods. By means of the method and the device the aim is to minimize the amount of hydrogen sulfide produced and at the same time achieve an efficient removal of sulfates from the deep NOx storage catalyst layers.

The object is achieved by the features of the independent claims. Advantageous embodiments of the invention are characterized in the dependent claims.

The invention is characterized by a method and a corresponding device for desulfating a NOx storage catalyst wherein the desulfation is performed in two phases. In a first phase, the NOx storage catalyst is operated alternately with rich and lean exhaust gas. In a subsequent second phase, the NOx storage catalyst is operated with rich exhaust gas. The method according to the invention consists in the combination of the two known desulfation methods. Compared with the method wherein the desulfation of the NOx storage catalyst is performed using rich exhaust gas, said combination produces the advantages that smaller quantities of hydrogen sulfide, hydrocarbons and carbon monoxide are produced, since the NOx storage catalyst is operated in the first phase alternately with rich and lean exhaust gas.

Compared with the method wherein the NOx storage catalyst is operated alternately with rich and lean exhaust gas during the desulfation, the method according to the invention advantageously enables an efficient complete desulfation of the NOx storage catalyst. Moreover, the sulfate present in the deep NOx storage catalyst layers is also removed by means of the second phase. Furthermore, the length of time required for the desulfation is reduced by means of the method according to the invention. The method according to the invention can be used both for diesel-powered internal combustion engines and for gasoline-powered internal combustion engines.

In an advantageous embodiment, the first phase is terminated when a predetermined amount of sulfates (e.g. greater than 50% relative to the total quantity trapped in the NOx storage catalyst prior to the start of the desulfation) has been removed from the NOx storage catalyst. In this way it is ensured that only small amounts of hydrogen sulfide are produced as a result of the desulfation.

In a further advantageous embodiment of the invention, the end time of the first desulfation phase is determined on the basis of the signals emitted by an exhaust gas probe that is positioned downstream of the NOx storage catalyst. By using the exhaust gas probe it is possible to determine the duration of the first phase particularly precisely and so minimize the amount of hydrogen sulfide produced.

In a further advantageous embodiment of the invention, the end time of the first desulfation phase is determined with the aid of a model for the removal of sulfates from the NOx storage catalyst. As a result of using the model it may be possible to dispense with the exhaust gas probe downstream of the NOx storage catalyst and consequently realize an exhaust gas purification system at low cost.

In a further advantageous embodiment, the second phase, and consequently the desulfation process, is terminated when the NOx storage catalyst is completely free of sulfates. The complete elimination of sulfates from the NOx storage catalyst establishes a fixed point of reference for all models that are used to model the sulfur deposition into or the sulfur removal from the NOx storage catalyst. Following the desulfation, the quantity of sulfates trapped in the NOx storage catalyst is set in the models to the value 0 g. Furthermore, as a result of the total elimination of the sulfates the maximum storage capacity of the NOx storage catalyst is made available once again for oxides of nitrogen.

In a further advantageous embodiment, the end time of the second desulfation phase is determined with the aid of a model for the removal of sulfates from the NOx storage catalyst. The period of time taken for the desulfation is optimized thanks to the use of the model. As a result, unnecessary hydrocarbon and carbon monoxide emissions are avoided.

In a further advantageous embodiment of the invention, the NOx storage capacity of the NOx storage catalyst is determined following the desulfation. The value established in this process is compared with the NOx storage capacity of the NOx storage catalyst when in its new condition. The result of the comparison constitutes a measure for the aging of the NOx storage catalyst.

In a further advantageous embodiment, the method according to the invention is applied to an internal combustion engine whose exhaust gas purification system includes a three-way catalyst or an oxidation catalyst in addition to the NOx storage catalyst. Particularly effective exhaust gas purification is achieved by the combination of the NOx storage catalyst with the three-way catalyst or the oxidation catalyst.

In a further advantageous embodiment, the method according to the invention is applied to an internal combustion engine which operates predominantly in the superstoichiometric mode (lean operation). Since large quantities of oxides of nitrogen are produced particularly during lean operation, particularly efficient reduction of the oxides of nitrogen is necessary. Toward that end, use can preferably be made of NOx storage catalysts which have to be purged of sulfates at defined intervals.

Exemplary embodiments of the invention are explained below with reference to the schematic drawings, in which:

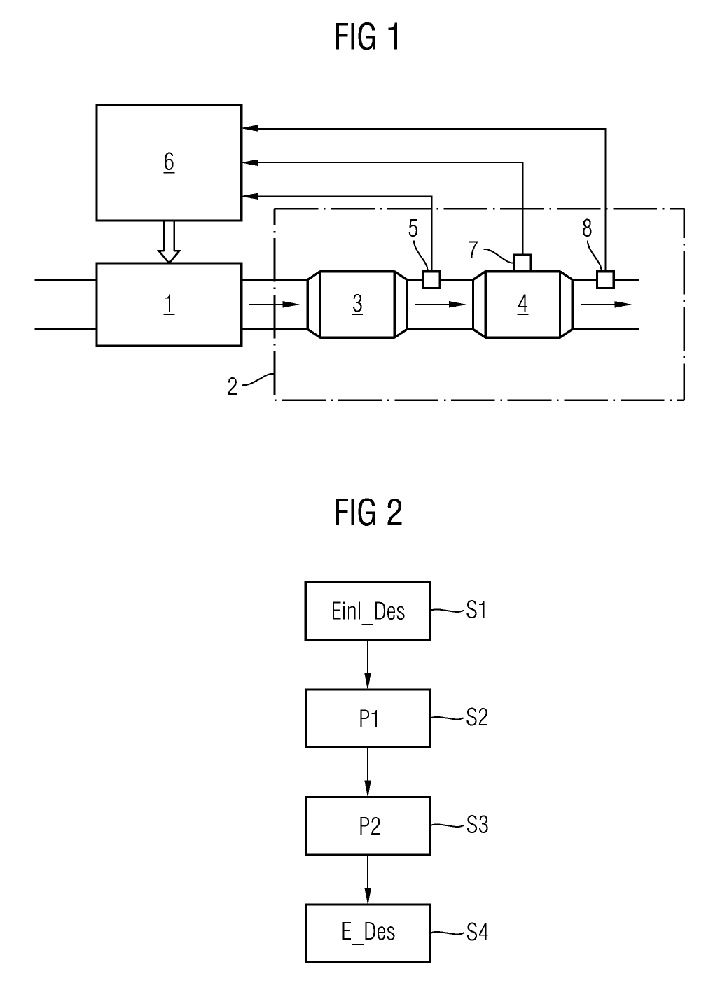

FIG. 1 shows an internal combustion engine having an exhaust gas purification system, and

FIG. 2 is a diagram intended to illustrate the method according to the invention.

FIG. 1 shows in greatly simplified form the schematic representation of an internal combustion engine 1 having an exhaust gas purification system 2. The exhaust gas purification system 2 has a three-way catalyst 3 and a NOx storage catalyst 4. The three-way catalyst 3 serves to reduce the amount of hydrocarbons and carbon monoxide in the exhaust gas. The purpose of the NOx storage catalyst 4 is to trap the oxides of nitrogen present in the exhaust gas.

The exhaust gas purification system 2 also includes an exhaust gas probe 5 which is arranged between the three-way catalyst 3 and the NOx storage catalyst 4 and measures the oxygen concentration in the exhaust gas. The signals emitted by the exhaust gas probe 5 are recorded by an electronic computing unit 6 which controls the mixture composition of the internal combustion engine 1.

The exhaust gas purification system 2 further includes a temperature sensor 7 which is mounted on the NOx storage catalyst 4 and measures the temperature of the NOx storage catalyst 4, the temperature sensor 7 also being connected on the output side to the electronic computing unit 6. It is necessary to measure the temperature of the NOx storage catalyst 4 because the NOx storage catalyst 4 has to be heated up at regular intervals for the purpose of the desulfation, with a defined minimum temperature needing to be reached in order to break down the trapped sulfates.

In addition, the exhaust gas purification system 2 has a further exhaust gas probe 8 which is positioned downstream of the NOx storage catalyst 4 and measures the exhaust gas composition downstream of the NOx storage catalyst 4 in order to be able to detect a breakthrough of the NOx storage catalyst 4. A breakthrough of the NOx storage catalyst 4 of said kind occurs when the absolute storage capacity of the NOx storage catalyst 4 is exceeded and the oxides of nitrogen contained in the exhaust gas of the internal combustion engine 1 can consequently no longer be stored in the NOx storage catalyst 4. The exhaust gas probe 8 can be implemented as a linear or binary lambda probe or as a probe by means of which the nitrogen concentration is measured. The signals emitted by the exhaust gas probe 8 are recorded by the electronic computing unit 6. They can be used for determining the end time of the first desulfation phase. The arrows shown in FIG. 1 indicate the flow direction of the exhaust gas.

FIG. 2 shows a diagram intended to illustrate the method according to the invention. To start with, the desulfation of the NOx storage catalyst 4 is initiated Einl_Des in step S1. The time at which the desulfation is initiated can be determined e.g. with the aid of models that are stored in the electronic computing unit 6. The models are used to determine the amount of sulfates trapped in the NOx storage catalyst 4. The first phase P1 of the desulfation is performed in step S2. The NOx storage catalyst 4 is operated alternately with rich and lean exhaust gas. The end time of the first phase P1 can be determined on the basis of the signals emitted by the exhaust gas probe 8 situated downstream of the NOx storage catalyst 4 or with the aid of a model residing in the electronic computing unit 6. Next, following termination of the first phase P1, the second phase P2 of the desulfation is performed in step S3. The NOx storage catalyst 4 is operated exclusively with rich exhaust gas in the second phase P2.

The second phase P2, and hence the desulfation of the NOx storage catalyst 4, is terminated E_Des in step S4. The end time of the second phase is determined with the aid of a model residing in the electronic computing unit 6. The second phase P2 is advantageously terminated E_Des when the NOx storage catalyst 4 is completely free of sulfates.

1-10. (canceled)

11. A method for desulfating a NOx storage catalytic converter of an exhaust gas purification system of an internal combustion engine, the method which comprises:
desulfating the NOx storage catalytic converter in two phases, including:
in a first phase, operating the NOx storage catalytic converter alternately with rich and lean exhaust gas; and
in a subsequent second phase, operating the NOx storage catalytic converter with rich exhaust gas.

12. The method according to claim 11, which comprises terminating the first phase of the desulfating step when a predetermined amount of sulfates has been removed from the NOx storage catalytic converter.

13. The method according to claim 11, which comprises determining an end time of the first phase on a basis of signals emitted by an exhaust gas probe positioned downstream of the NOx storage catalytic converter in an exhaust gas flow direction.

14. The method according to claim 11, which comprises determining an end time of the first phase with the aid of a model.

15. The method according to claim 11, which comprises terminating the second phase when the NOx storage catalytic converter is substantially completely free of sulfates.

16. The method according to claim 11, which comprises determining the end time of the second phase with the aid of a model.

17. The method according to claim 11, which comprises determining a NOx storage capacity of the NOx storage catalytic converter following the desulfating step.

18. The method according to claim 11, wherein the exhaust gas purification system includes a three-way catalytic converter or an oxidation catalytic converter.

19. The method according to claim 11, wherein the internal combustion engine operates predominantly in a super-stoichiometric range.

20. A device for desulfating a NOx storage catalytic converter associated with an exhaust gas purification system of an internal combustion engine, comprising:
means for desulfating the NOx storage catalytic converter in two phases, including:
means for alternately operating the NOx storage catalytic converter with rich and lean exhaust gas in a first phase; and
means for operating the NOx storage catalytic converter with rich exhaust gas in a subsequent second phase.
